(19) United States
(12) Patent Application Publication
(10) Pub. No.: US 2013/0246761 A1
(43) Pub. Date: Sep. 19, 2013

(54) REGISTER SHARING IN AN EXTENDED PROCESSOR ARCHITECTURE

(71) Applicants: Jeffrey H. Derby, Chapel Hill, NC (US); Amit Golander, Tel-Aviv (IL); Sagi Manole, Petach Tiqwa (IL)

(72) Inventors: Jeffrey H. Derby, Chapel Hill, NC (US); Amit Golander, Tel-Aviv (IL); Sagi Manole, Petach Tiqwa (IL)

(73) Assignee: International Business Machines Corporation, Armonk, NY (US)

(21) Appl. No.: 13/418,359

(22) Filed: Mar. 13, 2012

(51) Int. Cl. G06F 9/312

(52) U.S. Cl. 712/225; 712/E09.023; 712/E09.033

(57) ABSTRACT

Systems and methods are disclosed for sharing one or more registers in an extended processor architecture. The method comprises executing a first thread and a second thread on a processor core supported by an extended register file, wherein one or more registers in the extended register file are accessible by said first and second threads; loading first data for use by the first thread into a first set of physical registers mapped to a first set of logical registers associated with the first thread; and providing the first data for use by the second thread by maintaining the first data in the first set of physical registers and mapping set first set of physical registers to a second set of logical registers associated with the second thread.

### COPYRIGHT & TRADEMARK NOTICES

A portion of the disclosure of this patent document may contain material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of the applicant, the assignee, or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The disclosed subject matter relates generally to sharing data at register level in a processor architecture, and more particularly to improving the processing efficiency by sharing data loaded into a register for a first thread with a second thread that needs to access the same data.

### BACKGROUND

A processor register is a high speed but limited capacity data storage medium, generally, embedded on a processor chip so that data stored in the register can be readily accessed by the processor. Due to the limited storage capacity of the on-chip registers, data is first stored in a slower but larger data storage medium commonly referred to as the main memory. Data is then loaded from the main memory into the processor registers, where it is manipulated by one or more threads executed by the processor. A cache mechanism may be also implemented to further improve speed of data transfer from the main memory to the processor registers.

When a thread is executed by a processor, certain data values, represented by one or more variables, may be allocated to one or more processors registers. Typically, a thread loads the data separately into a dedicated register space for that thread, and the data is swapped in and out depending on the register size. With the availability of very large on-chip registers, it is possible to load large amounts of data into a dedicate register for a thread by way of a single load instruction, as opposed to loading smaller amounts of data, by way of multiple load instructions, into the traditionally available smaller registers.

Intrinsically, loading larger amounts of data into a very large register is relatively more time consuming than loading smaller amounts of data into a smaller register. Unfortunately, in the current processor architectures, two threads cannot share registers. That is, due to the dedicated nature of the registers, if data is loaded in a first very large register dedicated to a first thread, then a second thread that is interested in using the same data loaded in the first very large register cannot directly access the data.

In other words, each thread is associated with a dedicated register, such that if a second thread is interested in the same data that is loaded in the first register dedicated to a first thread, then said data will have to be loaded into a second register that is specifically dedicated to the second thread before the second thread is able to access the data. Thus, each thread independently loads the data to its dedicated registers that are never shared with another thread, even if both threads run on the same processor core at the same time.

### SUMMARY

For purposes of summarizing, certain aspects, advantages, and novel features have been described herein. It is to be understood that not all such advantages may be achieved in accordance with any one particular embodiment. Thus the disclosed subject matter may be embodied or carried out in a manner that achieves or optimizes one advantage or group of advantages without achieving all the advantages as may be taught or suggested herein.

In accordance with one embodiment, a method for sharing one or more registers in an extended processor architecture is provided. The method comprises executing a first thread and a second thread on a processor core supported by an extended register file, wherein one or more registers in the extended register file are accessible by said first and second threads; loading first data for use by the first thread into a first set of physical registers mapped to a first set of logical registers associated with the first thread; and providing the first data for use by the second thread by maintaining the first data in the first set of physical registers and mapping set first set of physical registers to a second set of logical registers associated with the second thread.

In accordance with an embodiment, a system comprising one or more logic units is provided. The one or more logic units are configured to perform the functions and operations associated with the above-disclosed methods. In yet another embodiment, a computer program product comprising a computer readable storage medium having a computer readable program is provided. The computer readable program when executed on a computer causes the computer to perform the functions and operations associated with the above-disclosed methods.

One or more of the above-disclosed embodiments in addition to certain alternatives are provided in further detail below with reference to the attached figures. The disclosed subject matter is not, however, limited to any particular embodiment disclosed.

### BRIEF DESCRIPTION OF THE DRAWINGS

The disclosed embodiments may be better understood by referring to the figures in the attached drawings, as provided below.

FIG. 1 illustrates a block diagram of a register management unit associated with a processor, in accordance with one embodiment.

FIG. 2 illustrate a block diagram of an exemplary mode of accessing a register file, in accordance with one embodiment.

FIG. 3 illustrates an exemplary schematic block diagram of a register access unit, in accordance with one embodiment.

FIG. 4 shows an exemplary translation table and an exemplary block bit vector structure (BBV) that is used for allocating blocks, in accordance with one embodiment

FIG. 5 shows how a single VSRF as shared by multiple threads running on a processor core, in accordance with one or more embodiments.

FIG. 6 shows how logical registers from different threads may share the same physical registers, in accordance with one embodiment.

FIG. 7 depicts an example of a suggested programming model for sharing registers, in accordance with one embodiment.

FIG. 8 shows an exemplary block diagram of a hardware environment in which the disclosed systems and methods may operate, in accordance with one embodiment.

FIG. 9 shows a block diagram of an exemplary software environment in which the disclosed systems and methods may operate, in accordance with one embodiment.

Features, elements, and aspects that are referenced by the same numerals in different figures represent the same, equivalent, or similar features, elements, or aspects, in accordance with an embodiment.

### DETAILED DESCRIPTION OF EXEMPLARY EMBODIMENTS

In the following paragraphs, numerous specific details are set forth to provide a thorough description of various embodiments. Other embodiments may be practiced without these specific details or with some variations in detail. In some instances, some features are described in less detail so as not to obscure other aspects. The level of detail associated with each of the elements or features should not be construed to qualify the novelty or importance of one feature over the others.

In accordance with one embodiment, in a multi-threaded (MT) environment, an extended processor architecture with thousands of very large registers is utilized to achieve better execution performance by keeping large fractions of data in the available registers to avoid the load and store instructions that otherwise would have to be utilized to constantly keep the right fraction of the data in a limited processor architecture (e.g. 32 in PowerPC GPR).

In one implementation, the extended architecture may use architectural indirection to access a large register file of 2K registers (e.g., virtual shared register file or VSRF). Optionally, said large register file is designed to physically support multiple logical register files belonging to different threads running on the same processor core. In the following, an exemplary use case in which two threads process the same data (Data1) as part of a joint task is provided:

T1, T2, T3 are threads

D1 and D2 are data blocks

Data1—data to be compressed
Compression:

Data2=CRC(Data1)—executed by thread1

Data3=deflate(Data1)—executed by thread2
Out=Data2 concatenated to Data3

In the above example, CRC and deflate are two different tasks needed as part of the compression process and may be parallelized to two different threads: the first will calculate the CRC on the data and the second will execute the deflate algorithm.

In one implementation suitable for smaller register files, the bytes of Data1 are loaded to both thread1 and thread2 registers. In another implementation suitable for larger register files (e.g., in extended core architectures), large fractions of Data1 are loaded into the dedicated register files. In the latter implementation, sharing the data stored in the dedicated register file for thread1 with thread2 will eliminate load instructions, save resources and reduce power consumption as provided in further detail below.

In the above example, to allow different threads to share registers, one thread (e.g., a primary thread) loads Data1 to its registers and allows another thread (e.g., a secondary thread) to directly use them (i.e., without reloading the same data from memory to new physical registers). Accordingly, fewer VSRF registers are exploited so that the register file's unused volume in entirety is effectively larger and may be used to process larger data chunks. In addition, the number of load instructions and the pressure on the load-store unit and interconnect is reduced.

In one embodiment, the translation table (TT) and the block bit vector (BBV) for the secondary thread are manipulated so that the BBV bits are a duplicate of the BBV bits for the primary thread that loaded the data to be shared first. After the primary thread is done accessing the data, the BBV bits for the primary thread are zeroed out, but that will have no affect on the BBV bits for the secondary thread. Each thread has its own translation table, and BBV to allocate physical space in the register. A function (e.g., VirtualAlloc) may be used to set the bits in the BBV for threads that share the same data.

In one implementation, the MT-shared VSRF is partitioned into blocks that are explicitly allocated using a software library (e.g., DARME with functions vsrflib_malloc and vsrflib_free) and an appropriate ISA extension (vsrf_malloc and vsrf_free). The library and ISA may be further extended to support register sharing and the hardware managed translation table may be leveraged for logical to physical register address translation that was originally introduced to support MT, as provided in further detail below.

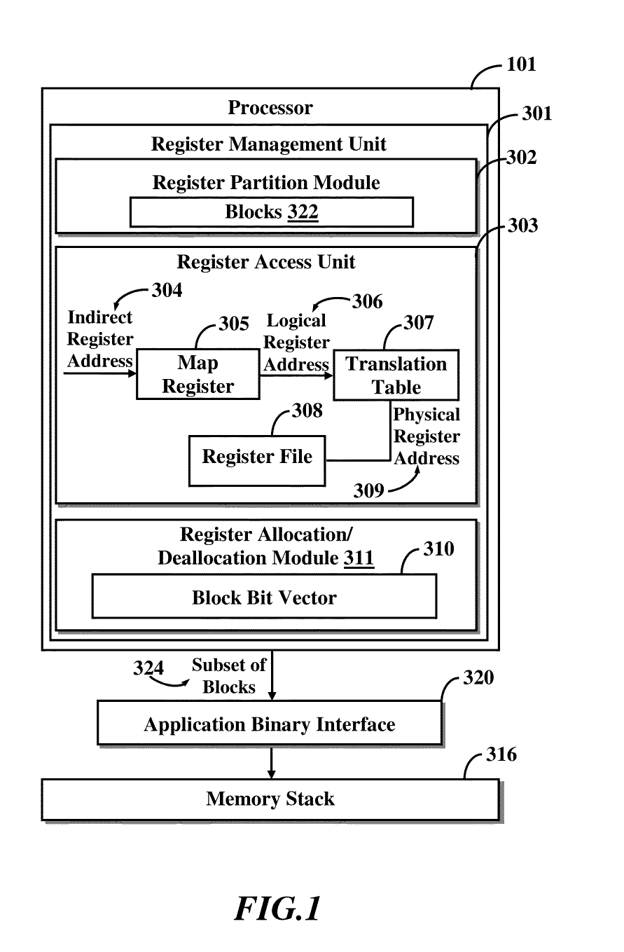

Referring to FIG. 1, an exemplary block diagram of a register management unit 301 in operational relationship with a processor 101 is shown, in accordance with one embodiment. The processor 101, communicates with register management unit 301 to manage an array of processor registers associated with the processor 101. The registers may form a large register file 308 (e.g., a vector-scalar register file for storing vector and scalar data). In one embodiment, the register file 308, for example, includes 4,096 registers that may be divided into a plurality of blocks (e.g., 32 blocks), each block having a plurality of registers (e.g., 128 registers). Other embodiments may include any number of registers or blocks.

The register file 308 is a high speed storage structure that is used to temporarily store data used by the processor 101. The register management unit 301 may include a register partition module 302, a register access unit 303, and a register allocation/deallocation module 311 to allocate/deallocate data blocks. The partition module 302 may be used to partition the register file 308 used by the processor 101 into a plurality of registers in register file 308. A subset 324 of the blocks of the register file 308 may be defined in an application binary interface (ABI) 320.

A register address generated by the processor 101 is herein referred as a logical register address, and an address loaded into the memory is herein referred as a physical register address. The register access unit 303 may include a translation table (TT) 307 and a map register (MR) 305. The logical register address (LRA) 306 is translated to a physical register address (PRA) 309 using the translation table (TT) 307. In an embodiment, the register file 308 may be indirectly accessed via the map register (MR) 305 that maps an indirection register address (IRA) 304 to the logical register address (LRA) 306.

The map register (MR) 305 may be a software-controlled indirection mechanism that allows, for example, a 5-bit operand to address a 12-bit logical register address. In an example embodiment, 5-bit operands may support up to 32 registers. The indirection mechanism of the map register 305 enables the operands to access a larger number of registers (e.g., 4,096 registers). In exemplary embodiments, the indirection register address (IRA) 304 may be used to map a 5-bit operand map to the most significant bits (MSBs) representing a block address. The least significant bits (LSBs) of the logical register address (LRA) 306 may represent an offset within the blocks 322.

In one implementation, a physical block may be allocated via an allocate instruction set added to an instruction set architecture. The allocate instruction set may receive the number of registers to be allocated as input and may return a first logical register of an allocated set. A block bit vector (BBV) 310 for each block in the register file 308 indicates to the hardware whether the block is already allocated or available to be allocated.

An allocated physical block may be freed via a de-allocate instruction set added to the instruction set architecture. Note that, in an optional embodiment, the TT 307 and BBV 310 are not part of the ABI 320. The subset of blocks 324 is pre-allocated and is exposed to the ABI 320 such that the application won't allocate and free the subset of blocks 324. Other blocks that are not exposed to the ABI 320 are controlled by the application and there is no implicit flow of data between the unexposed blocks and a memory stack 316 as a result of a function switch or a context switch.

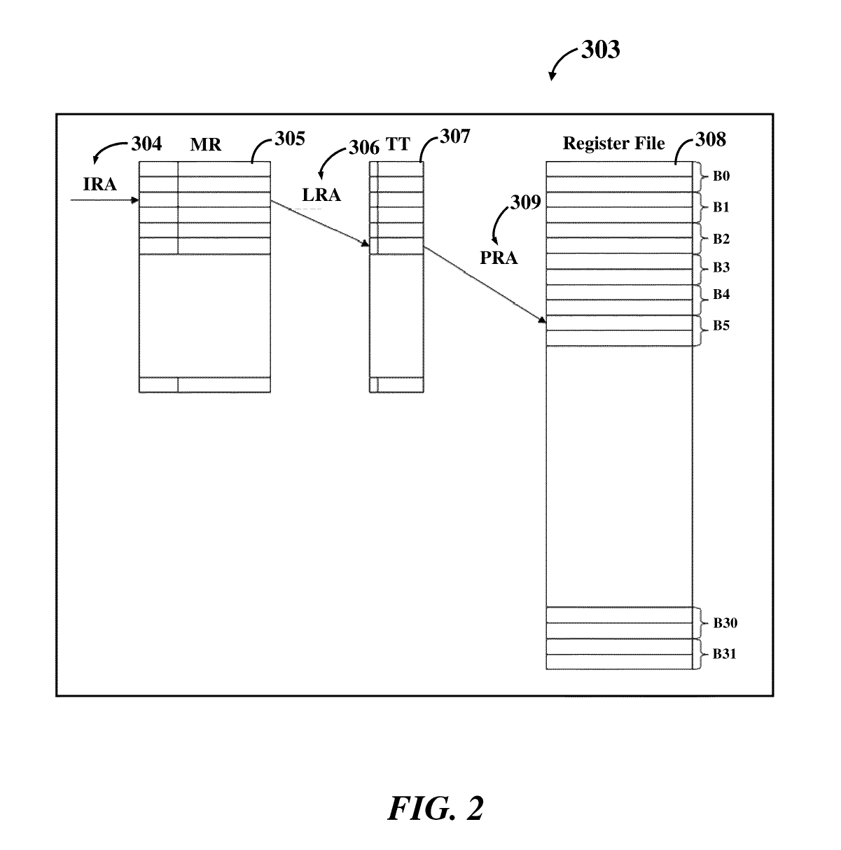

FIG. 2 is a block diagram showing an exemplary mode of accessing a register file 308, in accordance with one embodiment. In this exemplary embodiment, the register file 308 has 4K registers, assumed to be referenced by 12 bits. The register file 308 is accessed through the map register 305 (i.e., an indirection mechanism) that allows a 5 bit operand to address a 12 bit register file 308. The indirection is required to point to 4K registers through 5 bit operands, for example. In this embodiment, the register file 308 is partitioned into 128-register blocks (Bi), for example, Register access unit 303 is used to access the blocks. A logical register address 306 to a physical register address 308 translation is performed by a TT 307.

In one implementation, the physical blocks are allocated and de-allocated by instructions added to the instruction set architecture of the processor 101. An allocate instruction set (e.g., vsrf_malloc) receives the number of registers to be allocated (e.g., as aligned to block size) as an input and returns the first logical register of the allocated set (i.e., logically, not physically continuous). A de-allocate instruction set (e.g., vsrf_free) frees the logical set of blocks previously allocated. To allocate a vacant physical block, the hardware managed BBV 310 is used. The width of the BBV 310 is determined according to the size of the register file 308 and the number of blocks (i.e., 4K/128=32 in this example).

The register management unit 301 may map appropriate data elements of the source program and generate appropriate calls to an allocate instruction set and a de-allocate instruction set for allocation and de-allocation of the blocks 322. Programming-language extensions may extend the capabilities of a compiler by providing the programmer with the capabilities of the allocate instruction set and the de-allocate instruction set, with the help of the supporting compiler for the programming language. A compiler may be optimized by identifying opportunities of data reuse and prefetching, calling the allocate instruction set for allocation of register blocks, and calling the de-allocate instruction set for de-allocation of register blocks.

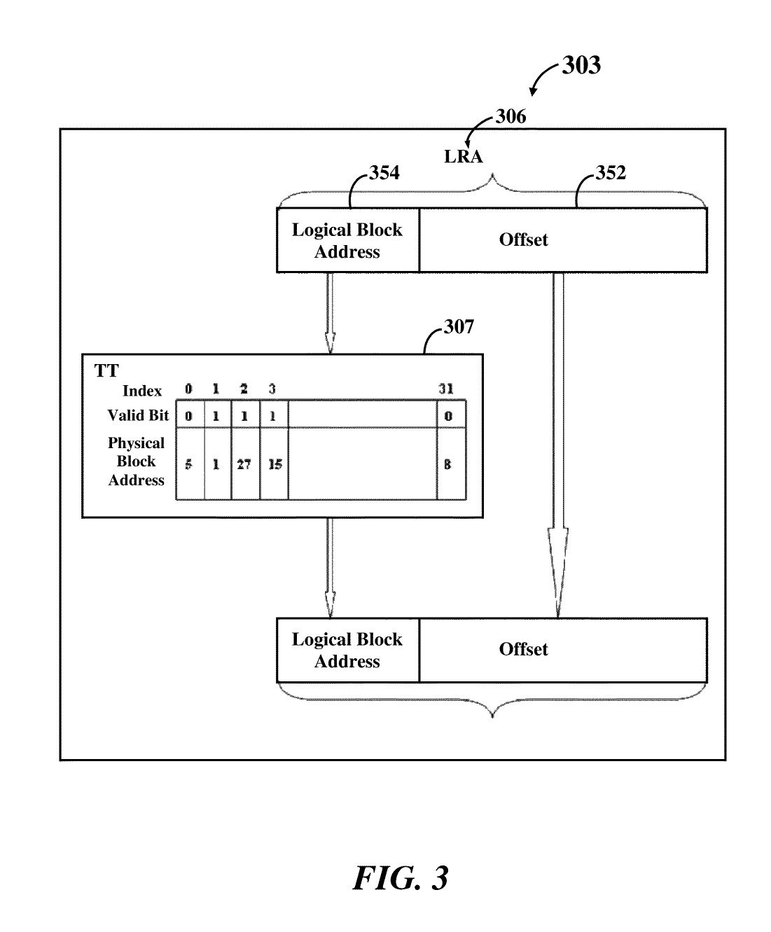

FIG. 3 illustrates an exemplary schematic block diagram of the register access unit 303, in accordance with one embodiment. Each entry of the map register 305 is divided into the least significant bits (LSBs) that represent offsets 352 within a block and the most significant bits (MSBs) that represent a block address 354. In this example, addressing 32 blocks may be done by a 5 bit block address. When multi-threading is desired, a translation table 307 is used per thread, or the translation table 307 may be enhanced to receive the thread number as part of the input.

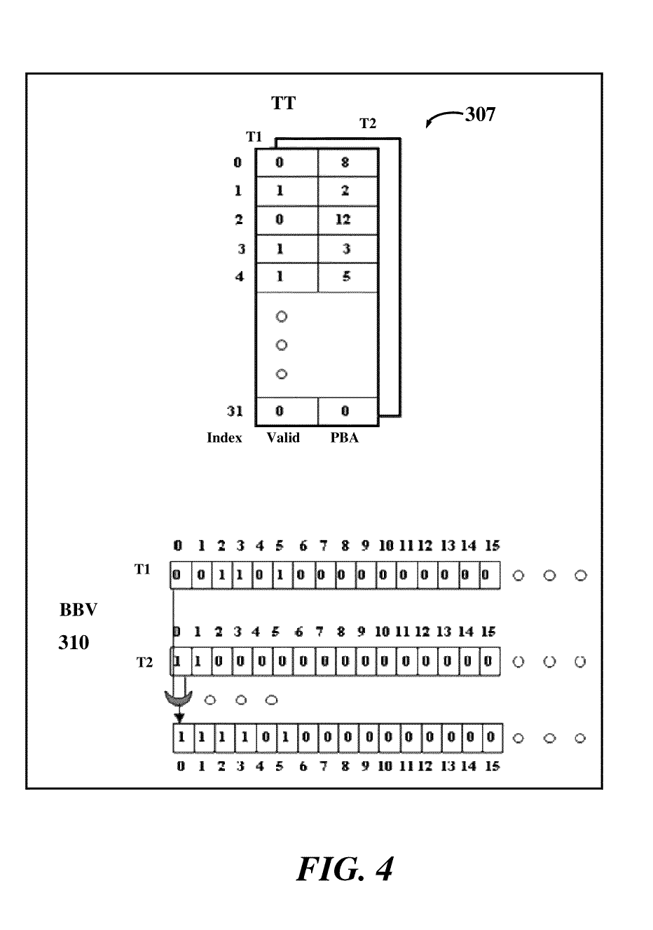

FIG. 4 shows an exemplary translation table 307 and an exemplary block bit vector structure (BBV) 310 that is used for allocating blocks 322, in accordance with one embodiment. Upon calling an allocate instruction set (e.g., vsrf_malloc), the register management unit 301 searches for a non-set bit in the BBV 310, allocates the associated block and updates the related entry of the translation table 307, according to the LRA 306 received from a run-time environment. If no vacant block is found, an alert (e.g., an “out-of-blocks/registers” exception) is invoked, for example.

In the example embodiment illustrated in FIG. 4, the set bit is a bit in the block bit vector that is set to “1” and a non-set bit is a bit that is set to “0”, for example. Bit i refers to any of the block bit vectors B0-B31 in this example embodiment. If bit i in the block bit vector 310 is set, then the physical Bi is allocated. When multi-threading is desired, a BBV is required per core and a bit-wise BBV (aggregated for all threads) is used. Upon calling a de-allocate instruction set (e.g., vsrf_free), the relevant entries of the translation table 307 and the BBV 310 associated bit are invalidated.

An allocate library function may be implemented to accept the number of blocks to be allocated as input, and search for continuous bits in the BBV 310. For example, to allocate 8 blocks, the allocate library function searches for 8 continuous bits in the BBV 310. If 8 continuous bits exist, the allocate library function may be called 8 times for allocating the 8 blocks and provide the first logical register per block. If 8 continuous bits do not exist, a reallocation instruction set may be called to perform compacting/defragmenting of the logical register and the physical register. A de-allocate library function frees one or more of the blocks within a pre-allocated region (e.g., 8 blocks) if a logical register address representing the start of the pre-allocated logical region is provided. An allocate library function may go over the BBV 310 for each thread.

A used block instruction set may be added to the instruction set architecture to monitor and return the number of physical registers that are allocated per thread during runtime. The number of allocated registers may be monitored in runtime by adding a BBV counter per BBV 310. The BBV counter is incremented/decremented if the block is allocated/freed. The BBV counter is then multiplied by the size of each block.

In the following disclosure, the terms provided below may be utilized in exemplary contexts that relate to a particular infrastructure or platform. It should be noted, however, that such references are purely exemplary in nature and should not be construed to limit the scope of the claimed subject matter to the disclosed exemplary details.
VSRF—Large register file (e.g., 2K registers, referenced by 12 bits)
MR—Map Register—the indirection mechanism (SW controlled) that allows a 5-bit operand address a 12-bit VSRF. MR, like VSRF is part of the architecture, for example.
IRA—Indirect Register Address—5-bit operand address to MR. LRA—Logical Register Address—12-bit address to the architectural VSRF. PRA—Physical Register Address—12-bit address to the physical/real VSRF, for example.

In one embodiment, a preliminary processing architecture that does not support register sharing may be provided where a large register file called (e.g., VSRF) is accessed through an indirection mechanism (e.g., MR) that allows an operand (IRA) address a VSRF register. In other architectures, the ISA may include a full-size LRA, making the indirection layer redundant.

Without loss of generality, in one implementation, the VSRF may be logically partitioned into a pre-defined number of register blocks (Bi). A logical to physical register address translation mechanism, one that uses a translation table (TT), may map the LRA to PRA. Physical blocks may be allocated and de-allocated by way of the following instructions:
vsrflib_malloc: receives a number of registers to be allocated and returns the first logical register of the allocated set (logically, not physically, continuous); and
vsrflib_free: frees the logical set of blocks previously allocated.

In one embodiment, to allocate a vacant physical block, a hardware-managed Block Bit Vector (BBV) may be used. The BBV width may be determined according to the VSRF size and number of blocks. If bit i in the BBV is set, then the physical Bi block is allocated. For an example, please refer to FIG. 2, in which the architecture and the flow of VSRF registers access are illustrated.

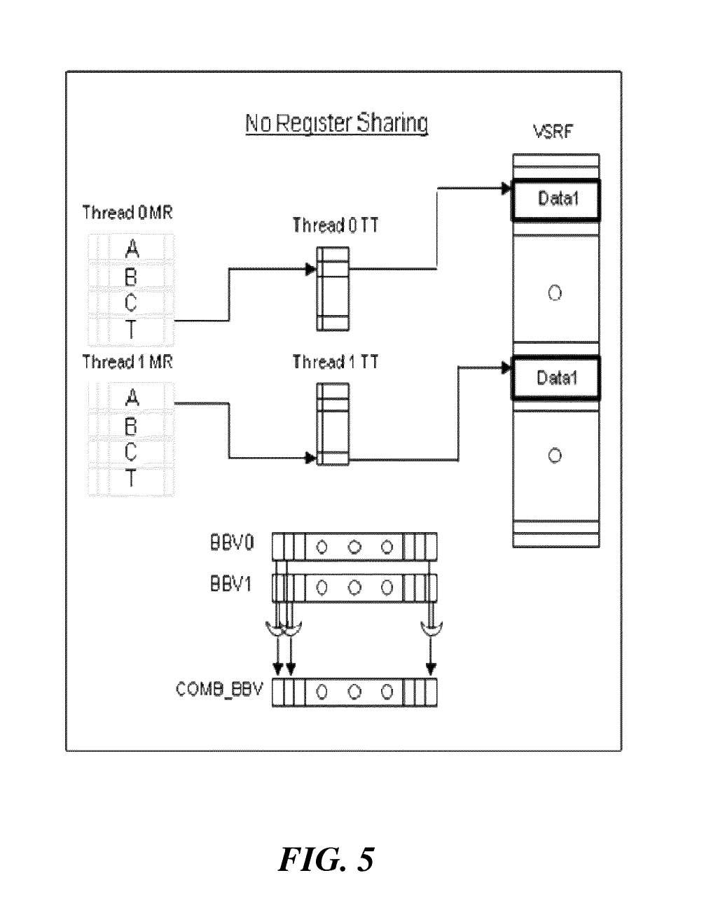

FIG. 5 shows how a single VSRF is shared by multiple threads (e.g., thread0 and thread1) running on a MT processor core. In an implementation that does not support register sharing, each thread has its own logical and physical registers and so pointers from different TTs never pointed to the same register in the VSRF. However, in an implementation that supports register sharing, register sharing may be supported by leveraging the TT structure.

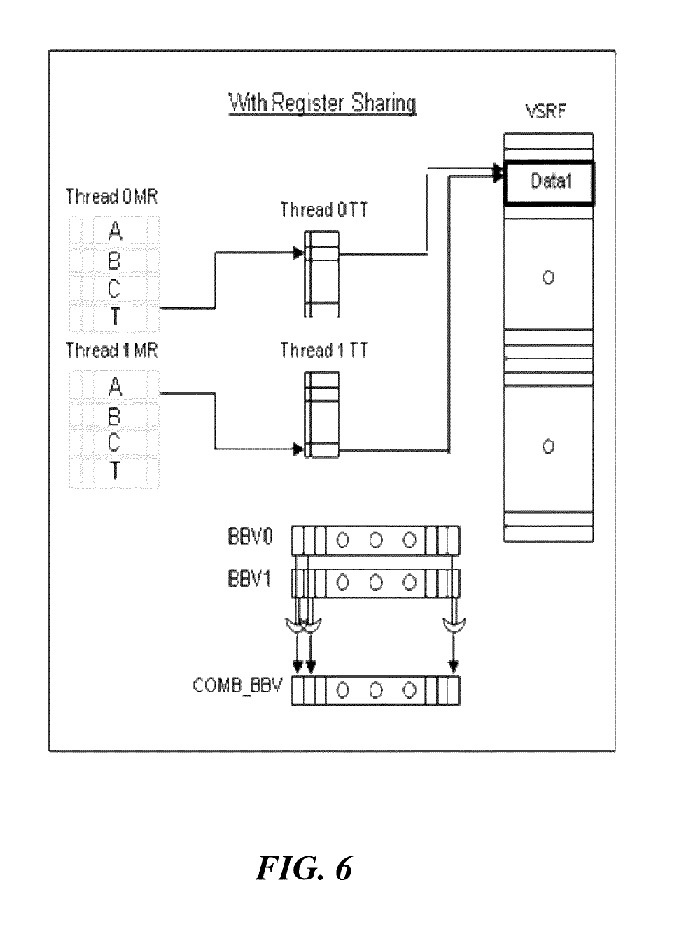

FIG. 6 shows how logical registers from different threads may share the same physical registers. The notion of sharing registers depends on the primary thread, which is responsible for loading the data to the shared registers and marking the registers as shared. Upon doing that, other threads, whether they run in the background or are created by the primary thread, may re-allocate the shared registers and access the shared registers.

Upon explicitly or implicitly marking that registers are ready to be shared, the primary thread allows other threads to re-allocate and access them. A library function called vsrflib_realloc may be utilized to receive the primary thread ID, the size of the shared area and the beginning of the logical shared address, and to logically allocate the same amount of registers for the calling thread, and call vsrf_realloc function for a block.

The vsrflib_realloc function may use an ISA instruction called vsrf_realloc. This instruction is responsible for copying the entry from the primary thread's TT to the re-allocating thread's TT. It then sets the appropriate bit in the re-allocating thread's BBV. As mentioned, the allocating-thread is responsible to allocate registers, load the data and mark them as shared.

Depending on implementation, the primary thread doesn't have to be scheduled while other threads access the shared registers, but may be switched out as long as its context is being locked by a Lazy CS mechanism which may be used to assure that the shared registers will not be removed for the favor of another thread's registers, so that other threads that re-allocated the shared registers may access them.

After allocating registers the primary thread has the responsibility of freeing or deallocating the registers. In one embodiment, the primary thread uses a library function called vsrflib_free, for example. This function receives a pointer to the register needed to be freed. The hardware is responsible for managing the BBV and so it resets the appropriate bit in the appropriate BBV.

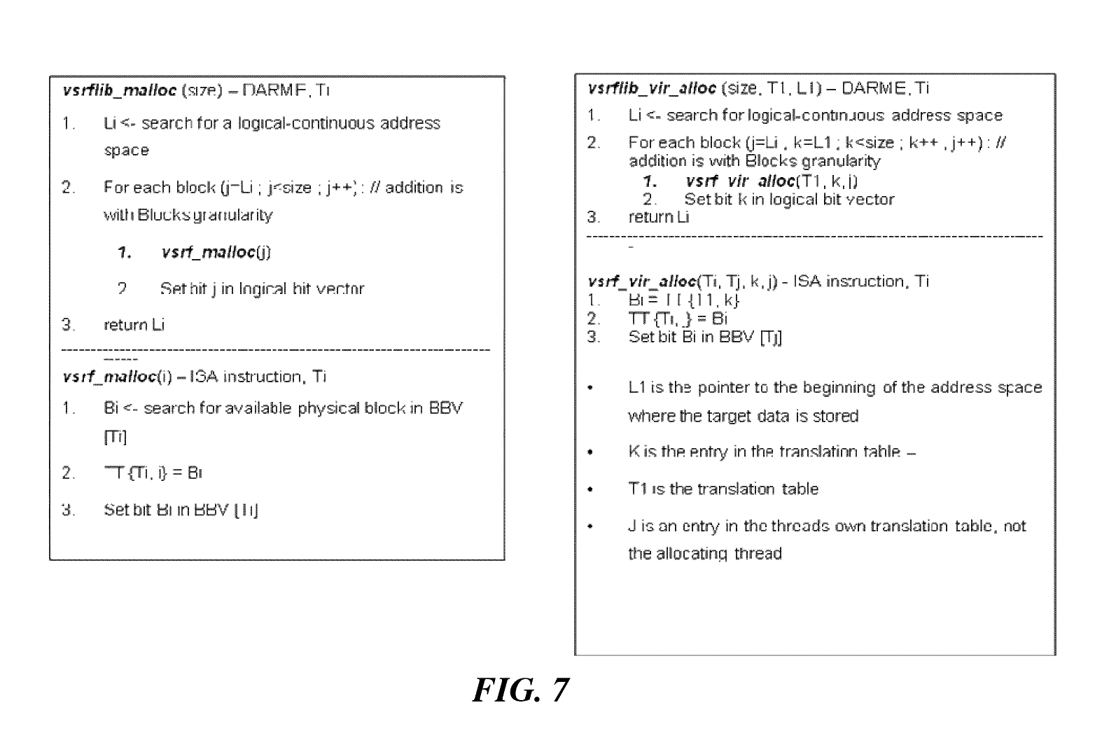

FIG. 7 depicts an example of a suggested programming model in accordance with one embodiment. On the left, the implementation in which registers are not shared is presented. As shown, each thread allocates and frees its own set of registers. On the right, the shared register approach is demonstrated, including the vsrflib_realloc library function and the vsrf_realloc ISA instruction designed for register sharing, for example. This is a behavior in which no CS occurs and the program is executed with no interference.

In some cases, due to either malicious program or OS CS, the hardware may fail the vsrf_realloc instruction, for example, and register sharing between two threads that belong to different processes may cause security issues. Such issues may be easily avoided by comparing the PID registers for the threads or consulting the OS/HV. Therefore, the vsrflib_realloc library function may be configured to check on the return code of the ISA instruction for failures, in one embodiment. To resolve the above issues, several approaches may be taken, such as waiting for a certain period of time and trying again or just using the baseline allocation function (e.g., vsrflib_malloc) to run independently from the primary thread.

For the purpose of the following example, we assume that two threads that share registers will run on the same processor core. In case of a full CS, in which a thread's context is to be fully switched out, the sharing threads are switched out as well and switched in to the same processor core (note that this doesn't necessary have to be the original core). This way, a situation in which a thread may have the ability to access other thread's registers without the other thread awareness may be avoided.

In order to support efficient function switching, an approach may be adopted in which a subset of registers within the VSRF is exposed to the ABI. The ABI itself may be aware of subset of registers and the others are allocated and freed outside the ABI. Registers pre-defined in the ABI may not be sharable as this would cause additional copies of register upon every function switching operation of all sharing threads.

In one embodiment, it may be desirable to limit the permissions. Re-allocating threads may have limited permissions to the shared register (e.g., read-only permissions). This may be implemented by adding a 2-bit field to each entry in the BBV, for example, to provide permissions of read/write to each allocated block. This way, each thread may have different permissions, while still accessing the same physical block. It is noteworthy that for the purpose of this disclosure, threads that run on the same processor core may be executed by fine-grain MT, course-grain MT, SMT or any other multithreading technique.

Moreover, depending on implementation, a large register file (VSFR) may be accessed through an indirection map-based mechanism by partitioning the VSRF to blocks (e.g., 32 blocks, 64 vector registers each), so that it would be accessed via 16-bit mapping (5-bit block granularity+6-bit vector register within a block+5-bit Byte within a vector register), for example. Synchronization between sharing threads may leverage any mechanism, such as the popular pthreads library as provided below.

In an example embodiment, an allocation function (e.g., vsrflib_malloc) may be used so that the hardware may allocate a register with blocks granularity (note there is no restriction to the number of vector registers within block). The user may provide the number of vector registers needed to allocate and the hardware will allocate the least amount of blocks to satisfy the request, for example.

In an optional architecture implemented for register sharing, a thread may incorporate its own set of MR and TT (regardless of sharing registers). Hence, when enabling sharing, a process that is executed is the duplication of entry/entries from one TT to the other. In this manner, loading the data to the VSRF becomes redundant.

In one embodiment, upon defining a vector and before loading data to the vector, the thread may mark a flag indicating it started to load the data into the vector registers. Upon load completion, the vector may mark the flag indicating it has done loading the data and the blocks of vector registers are ready for sharing.

When a second thread wants to access the data, the second thread checks for that flag. If the flag is marked as READY, for example, then the second thread may virtually allocate the same blocks and access them. If the flag is marked as STARTED or IDLE, the second thread may choose whether to wait for the primary thread to load the data or load the data by itself (including marking the blocks as STARTED and upon load completion as READY).

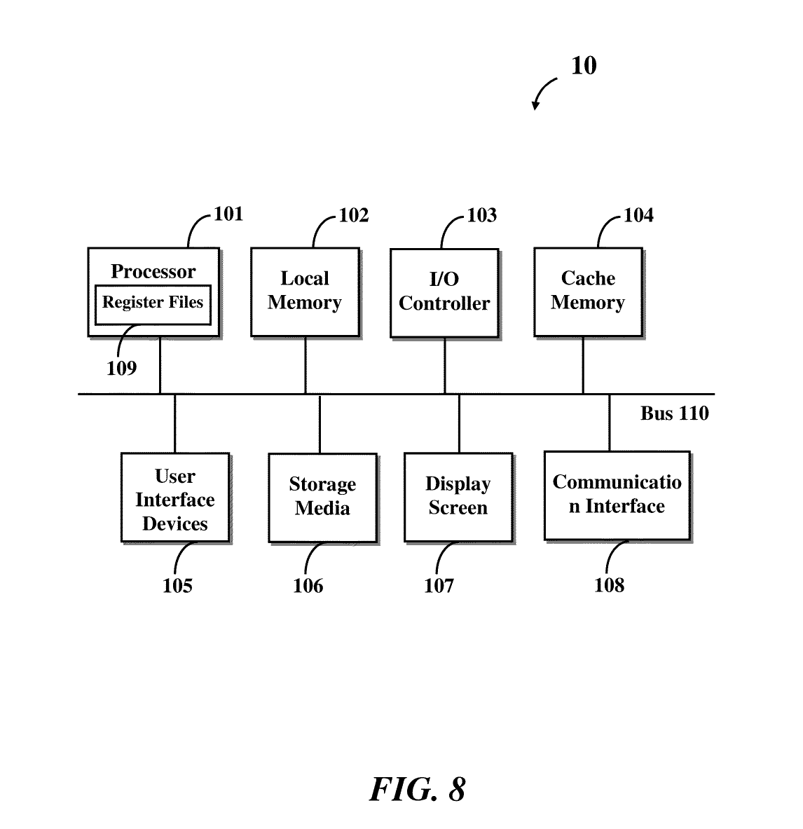

Referring to FIG. 8, a computing environment in accordance with an exemplary embodiment may be composed of a hardware environment 100 and a software environment 120. The hardware environment 100 may comprise logic units, circuits, or other machinery and equipment that provide an execution environment for the components of software environment 120. In turn, the software environment 120 may provide the execution instructions, including the underlying operational settings and configurations, for the various components of the hardware environment 100.

Application software and logic code disclosed herein may be implemented in the form of computer readable code executed over one or more computing systems represented by the exemplary hardware environment 100. As illustrated, the hardware environment 100 may comprise a processor 101 coupled to one or more storage elements by way of a system bus 110. The processor 101 may include one or more register files 109 to hold the data the processor 101 is currently working on.

The processor 101 may include one or more register files to maintain data or instructions relatively close to the processor 101 core. The storage elements in which the data is stored, for example, may comprise local memory 102, storage media 106, cache memory 104 or other computer-usable or computer readable media. Within the context of this disclosure, a computer usable or computer readable storage medium may include any recordable article that may be used to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-RAY), digital video disk (DVD), high definition video disk (HD-DVD) or Blue-ray™ disk.

In one embodiment, processor 101 loads executable code from storage media 106 to local memory 102. Cache memory 104 optimizes processing time by providing temporary storage that helps to reduce the number of times the code is loaded for execution. One or more user interface devices 105 (e.g., keyboard, pointing device, etc.) and a display screen 107 may be coupled to the other elements in the hardware environment 100 either directly or through an intervening I/O controller 103, for example. A communication interface unit 108, such as a network adapter, may be provided to enable the hardware environment 100 to communicate with local or remotely located computing systems, printers and storage devices via intervening private or public networks (e.g., the Internet). Wired or wireless modems and Ethernet cards are a few of the exemplary types of network adapters.

It is noteworthy that the hardware environment 100, in certain implementations, may not include some or all the above components, or may comprise additional components to provide supplemental functionality or utility. Depending on the contemplated use and configuration, hardware environment 100 may be a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, the communication interface 108 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

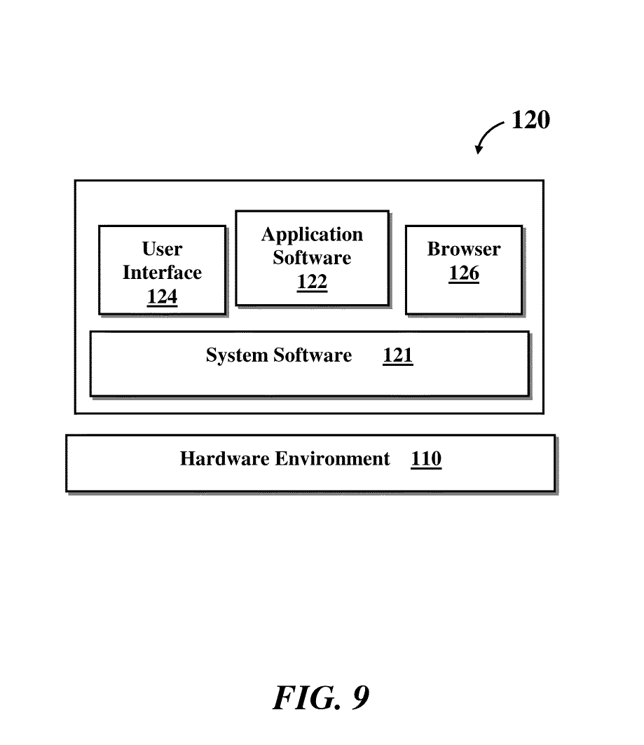

Referring to FIG. 9, a software environment 120 may be generally divided into two classes comprising system software 121 and application software 122 as executed on one or more hardware environments 100. In one embodiment, the methods and processes disclosed here may be implemented as system software 121, application software 122, or a combination thereof. System software 121 may comprise control programs, such as an operating system (OS) or an information management system, that instruct one or more processors 101 (e.g., microcontrollers) in the hardware environment 110 on how to function and process information. Application software 122 may comprise but is not limited to program code, data structures, firmware, resident software, microcode or any other form of information or routine that may be read, analyzed, or executed by a processor 101.

In other words, the application software 122 may be implemented as program code embedded in a computer program product in the form of a computer-usable or computer readable storage medium that provides program code for use by, or in connection with, a computer or any instruction execution system. Moreover, the application software 122 may comprise one or more computer programs that are executed on top of system software 121 after being loaded from the storage media 106 into the local memory 102. In client-server architecture, the application software 122 may comprise client software and server software. For example, in one embodiment, client software may be executed on a client computing system that is distinct and separable from a server computing system on which server software is executed.

Software environment 120 may also comprise browser software 126 for accessing data available over local or remote computing networks. Further, the software environment 120 may comprise a user interface 124 (e.g., a graphical user interface (GUI)) for receiving user commands and data). It is worthy to repeat that the hardware and software architectures and environments described above are for purposes of example. As such, an embodiment may be implemented over any type of system architecture, functional or logical platform or processing environment.

It should also be understood that the logic code, programs, modules, processes, methods, and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single, or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be used. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that may contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that may communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite the detailed nature of the exemplary embodiments provided, changes and modifications may be applied to said embodiments without limiting or departing from the generally intended scope. These and various other adaptations and combinations of the embodiments provided here are within the scope of the disclosed subject matter as defined by the claims and their full set of equivalents.

What is claimed is:

1. A computer-implemented method for sharing one or more registers in an extended processor architecture, the method comprising:
executing a first thread and a second thread on a processor core supported by an extended register file, wherein one or more registers in the extended register file are accessible by said first and second threads;
loading first data for use by the first thread into a first set of physical registers mapped to a first set of logical registers associated with the first thread; and
providing the first data for use by the second thread by maintaining the first data in the first set of physical registers and mapping set first set of physical registers to a second set of logical registers associated with the second thread.

2. The method of claim 1 further comprising locking access to the first set of physical registers containing the first data, while the first thread is updating the first data, to prevent the second thread from updating the first data.

3. The method of claim 2 further comprising unlocking access to the first set of physical registers containing the first data, after the first thread has completed updating the first data to allow the second thread to update the first data.

4. The method of claim 2 wherein while the first thread is updating the first data, access permissions are set so that the second thread is able to read the first data, but not able to update the first data.

5. The method of claim 1 wherein a subset of the first set of physical registers is mapped to the second set of logical registers, so that the second thread is able to access the subset of the first set of physical registers.

6. The method of claim 1 wherein the one or more shared registers are embedded in the extended processor architecture.

7. The method of claim 1 wherein the first set of logical registers are the same as the second set of logical registers.

8. A system comprising:
a processor core for executing a first thread and a second thread;
an extended register file, wherein one or more registers in the extended register file are accessible by said first and second threads;
a logic unit for loading first data for use by the first thread into a first set of physical registers mapped to a first set of logical registers associated with the first thread; and
a logic unit for providing the first data for use by the second thread by maintaining the first data in the first set of physical registers and mapping set first set of physical registers to a second set of logical registers associated with the second thread.

9. The system of claim 8 further comprising a logic unit for locking access to the first set of physical registers containing the first data, while the first thread is updating the first data, to prevent the second thread from updating the first data.

10. The system of claim 9 further comprising a logic unit for unlocking access to the first set of physical registers containing the first data, after the first thread has completed updating the first data to allow the second thread to update the first data.

11. The system of claim 9 wherein while the first thread is updating the first data, access permissions are set so that the second thread is able to read the first data, but not able to update the first data.

12. The system of claim 8 wherein a subset of the first set of physical registers is mapped to the second set of logical registers, so that the second thread is able to access the subset of the first set of physical registers.

13. The system of claim 8 wherein the one or more shared registers are embedded in the extended processor architecture.

14. The system of claim 8 wherein the first set of logical registers are the same as the second set of logical registers.

15. A computer program product comprising a non-transitory computer readable storage medium having a computer readable program, wherein the computer readable program when executed on a computer causes the computer to:
execute a first thread and a second thread on a processor core supported by an extended register file, wherein one or more registers in the extended register file are accessible by said first and second threads;
load first data for use by the first thread into a first set of physical registers mapped to a first set of logical registers associated with the first thread; and
provide the first data for use by the second thread by maintaining the first data in the first set of physical registers and mapping set first set of physical registers to a second set of logical registers associated with the second thread.

16. The computer program product of claim 15 wherein access to the first set of physical registers containing the first data is locked, while the first thread is updating the first data, to prevent the second thread from updating the first data.

17. The computer program product of claim 16 wherein access to the first set of physical registers containing the first data is locked, after the first thread has completed updating the first data to allow the second thread to update the first data.

18. The computer program product of claim 16 wherein while the first thread is updating the first data, access permissions are set so that the second thread is able to read the first data, but not able to update the first data.

19. The computer program product of claim 15 wherein the one or more shared registers are embedded in the extended processor architecture.

20. The computer program product of claim 15 wherein the first set of logical registers are the same as the second set of logical registers.
